(19) United States
(12) Patent Application Publication
(10) Pub. No.: US 2015/0161580 A1
(43) Pub. Date: Jun. 11, 2015

(54) USER AUTHENTICATION APPARATUS AND METHOD FOR POS SYSTEM

(71) Applicant: SEJOONGIS CO., LTD., Daegu-si (KR)

(72) Inventor: Jin Hyun SEOL, Daegu-si (KR)

(21) Appl. No.: 14/564,514

(22) Filed: Dec. 9, 2014

Related U.S. Application Data
(60) Provisional application No. 61/913,717, filed on Dec. 9, 2013.

(51) Int. Cl. G06Q 20/20; G06F 17/30; G06K 9/00

(52) U.S. Cl. CPC G06Q 20/206; G06K 9/00288; G06F 17/3028

(57) ABSTRACT

The present invention relates to a technology which acquires a face image of a user through a camera installed in a signature pad when a user pays with a payment card such as a credit card or check card in a shop, estimates the sex and age of the user based on the face image, and perform user authentication based on the estimation result. Thus, when such a technology is used, it is possible to distinguish a stolen or lost payment card or a payment card used by an unauthorized person, thereby preventing a financial accident.

### CROSS REFERENCE TO RELATED APPLICATIONS

This patent application claims priority to and the benefit of U.S. Provisional Patent Application No. 61/913,717, filed Dec. 9, 2013, the entire contents of which are incorporated herein by reference.

### BACKGROUND

1. Technical Field

The present disclosure relates to a user authentication technology for a point of sale data capture (POS) system, and more particularly, to a user authentication apparatus and method for a POS system, which acquires an image of a user's face through a signature pad and utilizes the acquired image for user authentication.

2. Related Art

FIG. 1 is a block diagram of a conventional POS system. As illustrated in FIG. 1, the POS system 100 includes a signature pad device 110, a POS terminal 120, a database (DB) 130, and a card reader 140.

The card reader 140 reads payment information of a payment card such as a credit card or check card, presented by a user, and transmits the read payment information to the POS terminal 120.

The signature pad device 110 receives an electronic signature from the user, and transmits the electronic signature information to the POS terminal 120.

The POS terminal 120 stores the payment information received from the card reader 140 and the electronic signature information received from the signature pad device 110 in the DB 130. Then, one payment process is completed.

As such, the conventional POS system authenticates a payment cart based on only electronic signature information inputted through the signature pad device. In this case, there are difficulties in distinguishing a stolen or lost payment card or a payment card used by an unauthorized person. Thus, a financial accident may occur.

### SUMMARY

Various embodiments are directed to a user authentication apparatus and method which acquires a face image of a user through a camera installed in a signature pad device, performs clientele analysis to recognize the sex and age information of the user from the face image, and perform user authentication using the clientele analysis result.

In an embodiment, a user authentication apparatus for a POS system may include: a signature pad device configured to take an image of a user's face when the user puts an electronic signature to a signature pad in order to pay with a payment card, and transmit the electronic signature information and the taken face image; and a POS terminal configured to acquire age and sex information from the face image received from the signature pad device by performing clientele analysis on the face image information of the user and store the acquired age and sex information in a DB, when storing data containing a product name or price at a point of sale in the DB.

In an embodiment, a user authentication apparatus for a POS system may include: a signature pad device configured to acquire a face image by taking an image of a user's face when the user puts an electronic signature to a signature pad in order to pay with a payment card, acquire age and sex information of the user by performing clientele analysis on the face image, and transmit the signature information of the user and the acquired age and sex information of the user; and a POS terminal configured to receive the electronic signature information and the age and sex information of the user from the signature pad device, and store the received information in a DB.

In an embodiment, a user authentication method for a POS system may include: acquiring, by a POS terminal, biometric information from a payment card when a user pays with the payment card, and requesting electronic signature information and face image information from a signature pad device; taking, by the signature pad device, an image of the user's face through a camera module mounted in the signature pad device when the user puts an electronic signature to a signature pad, acquiring clientele analysis information containing age and sex information by performing a clientele analysis process on the taken face image, and transmitting the electronic signature information and the clientele analysis information; and recognizing, by the POS terminal, the user's face by receiving the clientele analysis information from the signature pad device, and performing user authentication based on the face recognition result.

### BRIEF DESCRIPTION OF THE DRAWINGS

FIG. 1 is a block diagram of a conventional point of sale data capture (POS) system.

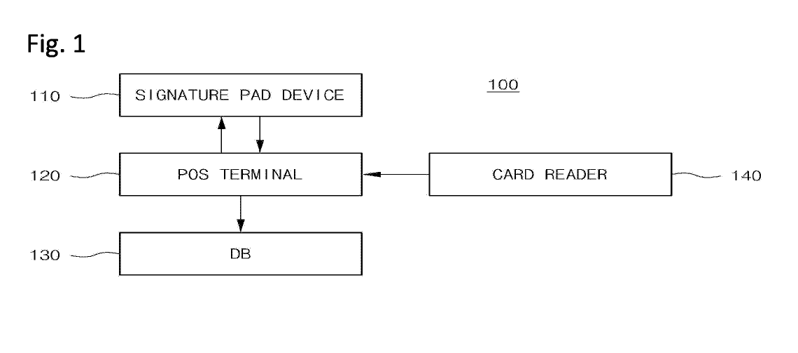

FIG. 2A is a block diagram illustrating the entire concept of a user authentication apparatus for a POS system in accordance with an embodiment of the present invention.

FIG. 2B is a detailed diagram of the signature pad device in accordance with the embodiment of the present invention.

FIG. 3A is a block diagram of a user authentication apparatus for a POS system in accordance with a first embodiment of the present invention.

FIG. 3B is a diagram for explaining operations of blocks included in the user authentication apparatus for the POS system in accordance with the first embodiment of the present invention.

FIG. 3C is a flowchart illustrating the entire operation of the user authentication apparatus for the POS system in accordance with the first embodiment of the present invention.

FIG. 4A is a block diagram of a user authentication apparatus for a POS system in accordance with a second embodiment of the present invention.

FIG. 4B is a diagram for explaining operations of blocks included in the user authentication apparatus for the POS system in accordance with the second embodiment of the present invention.

FIG. 4C is a flowchart illustrating the entire operation of the user authentication apparatus for the POS system in accordance with the second embodiment of the present invention.

FIG. 5 is a block diagram of a user authentication apparatus for a POS system in accordance with a third embodiment of the present invention.

FIG. 6 is a flowchart of a user authentication method for a POS system in accordance with a fourth embodiment of the present invention.

FIG. 7 is a detailed flowchart of a clientele analysis process in FIG. 6.

### DETAILED DESCRIPTION

Exemplary embodiments will be described below in more detail with reference to the accompanying drawings. The disclosure may, however, be embodied in different forms and should not be constructed as limited to the embodiments set forth herein. Rather, these embodiments are provided so that this disclosure will be thorough and complete, and will fully convey the scope of the disclosure to those skilled in the art. Throughout the disclosure, like reference numerals refer to like parts throughout the various figures and embodiments of the disclosure.

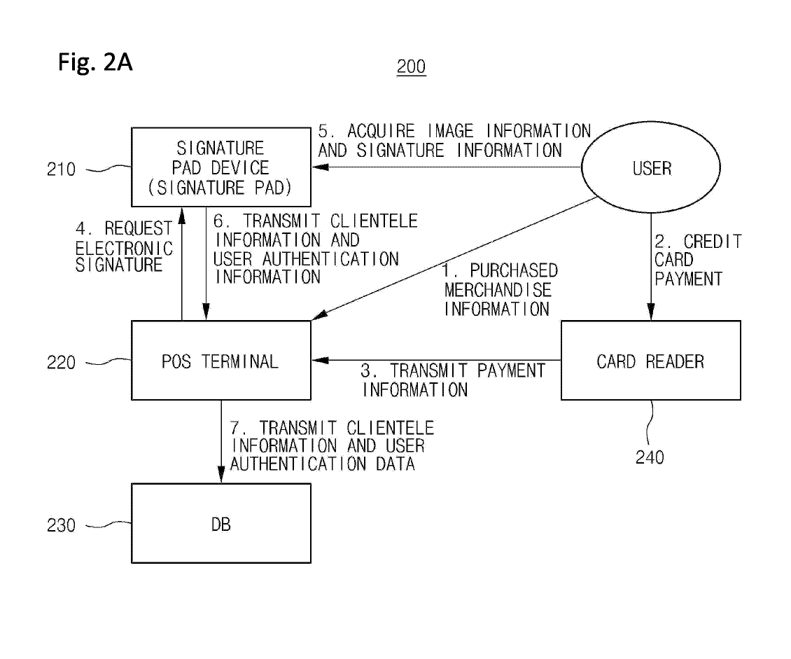

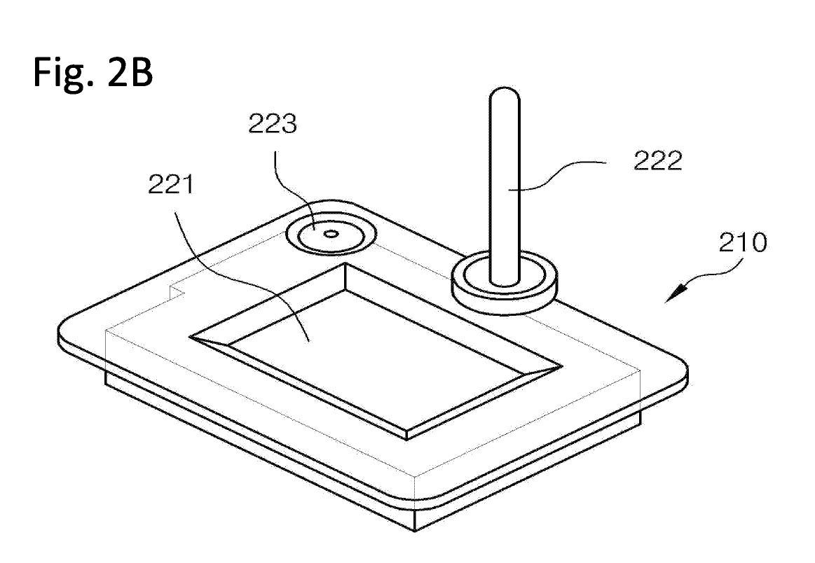

FIG. 2A is a block diagram illustrating the entire concept of a user authentication apparatus for a point of sale data capture (POS) system in accordance with an embodiment of the present invention. As illustrated in FIG. 2A, the POS system 200 may include a signature pad device 210, a POS terminal 220, a DB 230, and a card reader 240.

The card reader 240 may read payment information and biometric information stored in a payment card such as a credit card or check card, which is presented by a user, and transmit the read information to the POS terminal 220.

FIG. 2B is a diagram illustrating an example of the signature pad device in accordance with the embodiment of the present invention. As illustrated in FIG. 2B, the signature pad device 210 may include a signature pad module 221, a signature pen 222, and a camera module 223.

Referring to FIG. 2B, the signature pad device 210 may recognize an electronic signature which a user puts to the signature pad module 221 using the signature pen 222, and output the electronic signature information to the POS terminal 220. The signature pad device 210 may take an image of the user's face through a camera module 223 installed around the signature pad module 221, when the user puts the electronic signature to the signature pad module 221 using the signature pen 222 as described above. Then, the signature pad device 210 may perform clientele analysis on the taken image, recognize clientele information such as the sex and age of the user, and output the recognized clientele analysis to the POS terminal 220.

The POS terminal 220 may store the payment information received from the card reader 240 in the DB 230, and store the clientele information and authentication data received from the signature pad device 210 in the DB 230.

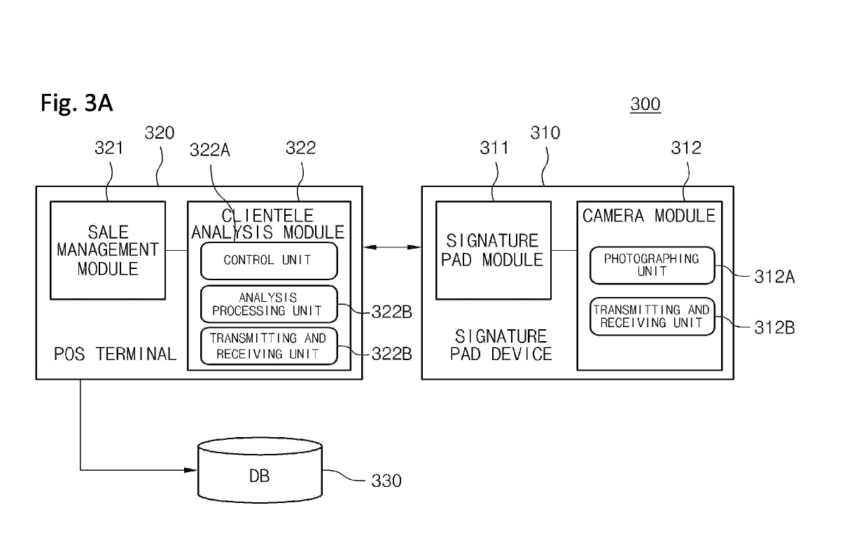

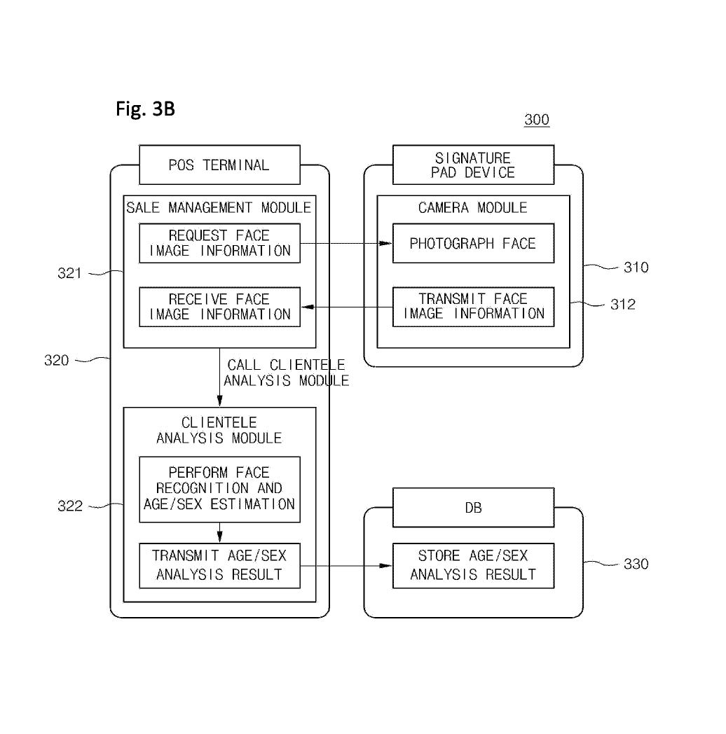

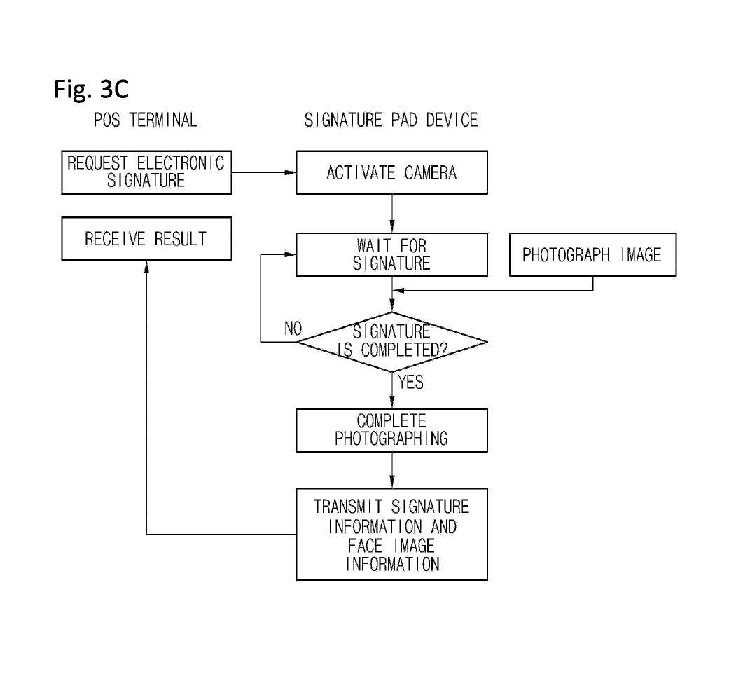

FIG. 3A is a block diagram of a user authentication apparatus for a POS system in accordance with a first embodiment of the present invention. As illustrated in FIG. 3A, the POS system 300 may include a signature pad device 310, a POS terminal 320, and a DB 330.

The signature pad device 310 may include a signature pad module 311 and a camera module 312. The camera module 312 may include a photographing unit 312A and a transmitting and receiving unit 312B.

The POS terminal 320 may include a sale management module 321 and a clientele analysis module 322. The clientele analysis module 322 may include a control unit 322A, an analysis processing unit 322B, and a transmitting and receiving unit 322C.

FIG. 3B is a diagram for explaining the operations of the respective blocks in the user authentication apparatus for the POS system in accordance with the first embodiment of the present invention.

FIG. 3C is a flowchart illustrating the entire operation of the user authentication apparatus for the POS system in accordance with the first embodiment of the present invention.

Referring to FIGS. 3A to 3C, the first embodiment of the present invention will be described as follows.

When a user makes a payment request using a payment card, the sale management module 321 of the POS terminal 320 may request an electronic signature from the signature pad device 310, while requesting face image information of a user.

Thus, the signature pad device 310 may activate the camera module 312, and then wait for an electronic signature of the user. Then, when the user puts an electronic signature to the signature pad module 311, the camera module 312 may take an image of the user's face. The taken face image may be transmitted to the sale management module 321 through the transmitting and receiving unit 321B.

At this time, the user may stare at the signature pad module 311 in order to put an electronic signature to the signature pad module 311, and a distance between the user's face and the signature pad module 311 may be maintained at a predetermined distance. Thus, when the user's face is photographed through the camera module 312 installed around the signature pad module 311, it is possible to acquire a satisfactorily clear face image.

The sale management module 321 may transmit the face image information received from the signature pad device 310 to the clientele analysis module 322.

The clientele analysis module 322 may perform clientele analysis to recognize the face image information of the user, received from the sale management module 321, acquire the age and sex (male/female) information of the user, and then store the acquired information in the DB 330.

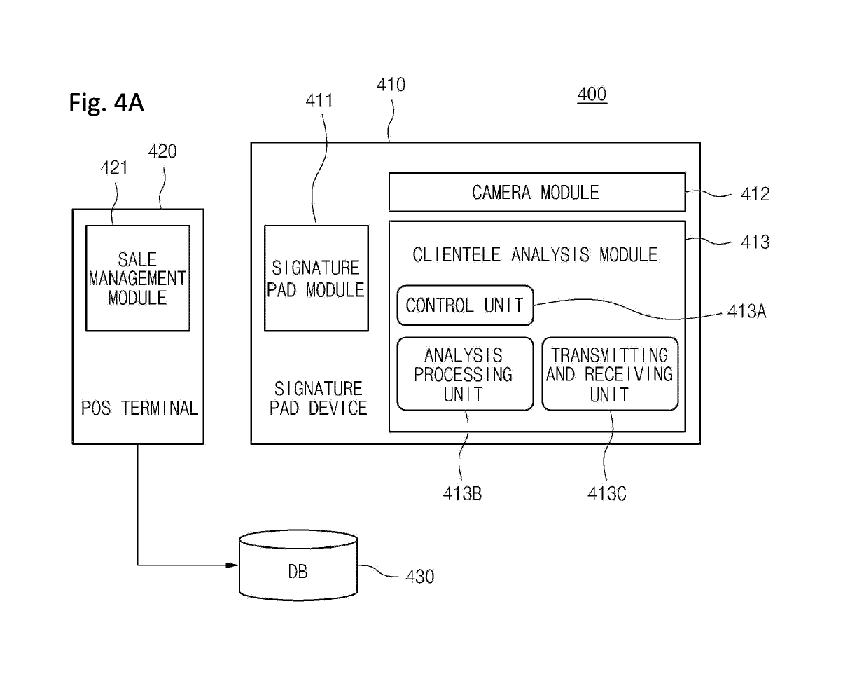

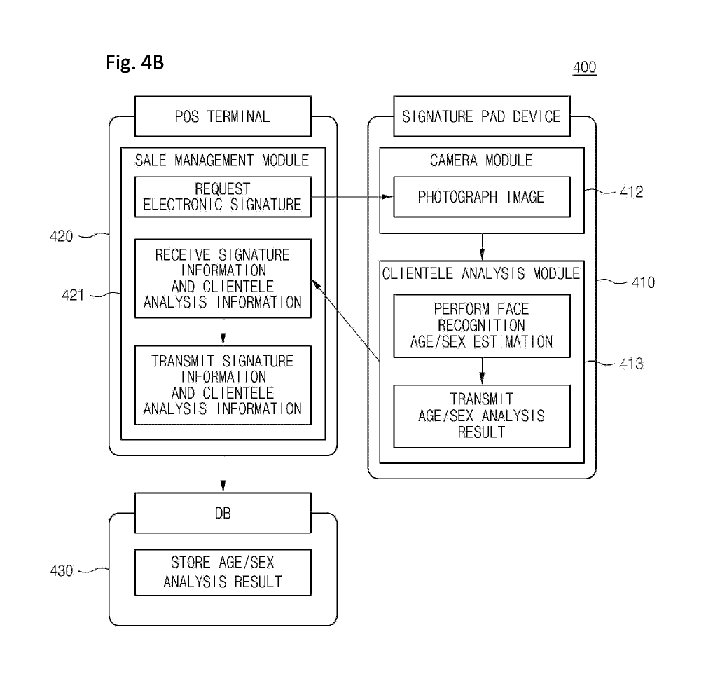

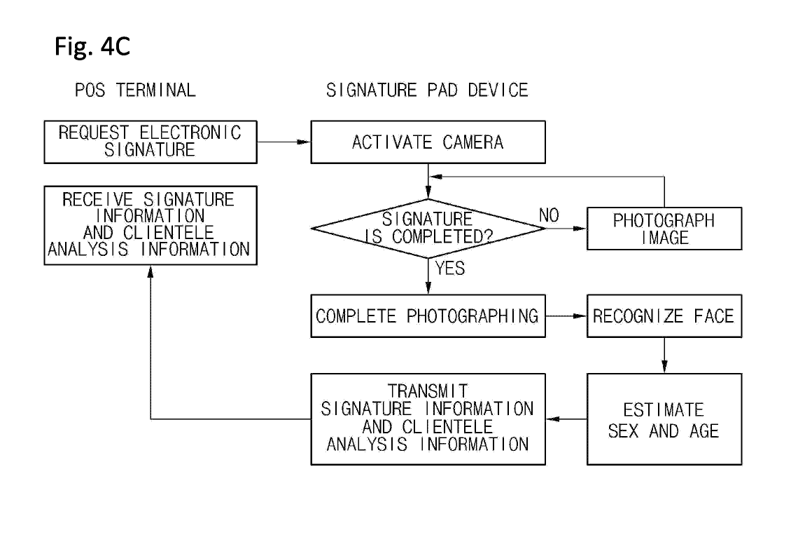

FIG. 4A is a block diagram of a user authentication apparatus for a POS system in accordance with a second embodiment of the present invention. As illustrated in FIG. 4A, the POS system 400 may include a signature pad device 410, a POS terminal 420, and a DB 430.

The signature pad device 410 may include a signature pad module 411, a camera module 412, and a clientele analysis module 413. The clientele analysis module 413 may include a control unit 413A, an analysis processing unit 413B, and a transmitting and receiving unit 413C.

FIG. 4B is a diagram for explaining the operations of the respective blocks in the user authentication apparatus for the POS system in accordance with the second embodiment of the present invention.

FIG. 4C is a flowchart illustrating the entire operation of the user authentication apparatus for the POS system in accordance with the second embodiment of the present invention.

Referring to FIGS. 4A to 4C, the second embodiment of the present invention will be described as follows.

When a user makes a payment request using a payment card, the sale management module 421 of the POS terminal 420 may request an electronic signature from the signature pad device 410.

Thus, the signature pad device 410 may activate the camera module 412, and then wait for an electronic signature of a user. Then, when the user puts an electronic signature to the signature pad module 411, the camera module 412 may take an image of the user's face. The camera module 412 may transmit the taken face image to the clientele analysis module 413.

In this case, a satisfactorily clear face image may be acquired through the camera module 412.

The analysis processing unit 413B of the clientele analysis module 413 may perform clientele analysis to recognize the face image information of the user, received from the camera module 412, and acquire the age and sex (male/female) information of the user. The transmitting and receiving unit 413C may transmit the age and sex information acquired through the analysis processing unit 413B to the sale management module 421. The sale management module 421 may receive the signature information and the clientele analysis information (face image information) from the signature pad device 410, and store the received information in the DB 430.

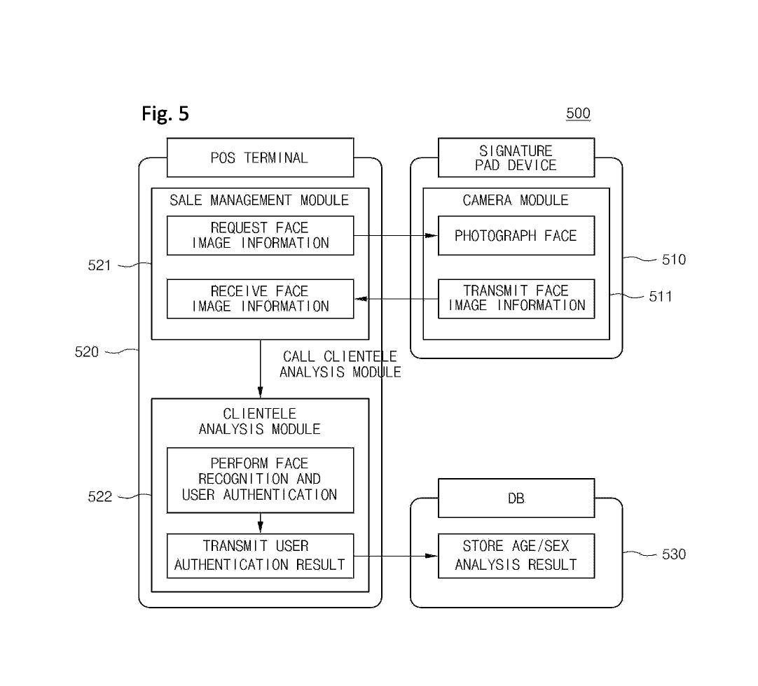

FIG. 5 is a block diagram of a user authentication apparatus for a POS system in accordance with a third embodiment of the present invention. As illustrated in FIG. 5, the POS system 500 may include a signature pad device 510, a POS terminal 520, and a DB 530.

The signature pad device 510 may include a camera module 511. The POS terminal 520 may include a sale management module 521 and a clientele analysis module 522.

The third embodiment of FIG. 5 is different from the second embodiment of FIG. 4B in that the clientele analysis module 522 of the POS terminal 520 performs face recognition and user authentication and transmits the authentication result to the DB 530.

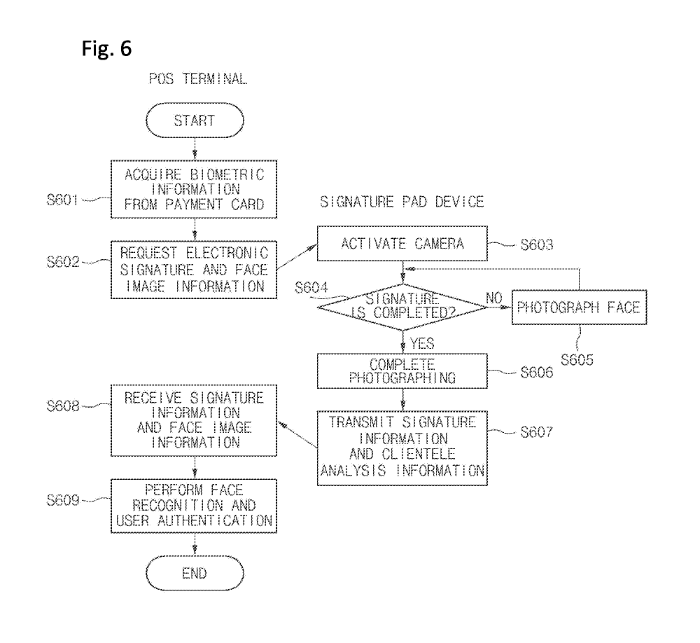

FIG. 6 is a flowchart of a user authentication method for a POS system in accordance with a fourth embodiment of the present invention. The user authentication method will be described as follows.

When a user makes a payment request using a payment card, the POS terminal may acquire biometric information from the payment card, and then request electronic signature information and face image information from the signature pad device, at steps 601 and 602.

Thus, the signature pad device may activate the camera module and then wait for an electronic signature from the user. When the user puts an electronic signature to the signature pad, the camera module installed in the signature pad device may take an image of the user's face, at steps S603 to S606.

Then, the signature pad device may perform clientele analysis to recognize the face image information of the user from the taken face image, acquire the electronic signature information and clientele analysis information including the age and sex information of the user, and transmit the acquired information to the POS terminal at step S607.

At this time, the POS terminal may recognize the user's face by receiving the electronic signature information and the face image information from the signature pad device, and perform user authentication based on the face recognition result, at step S608 and S609.

Thus, the user authentication for the user of the payment card may be more reliably performed.

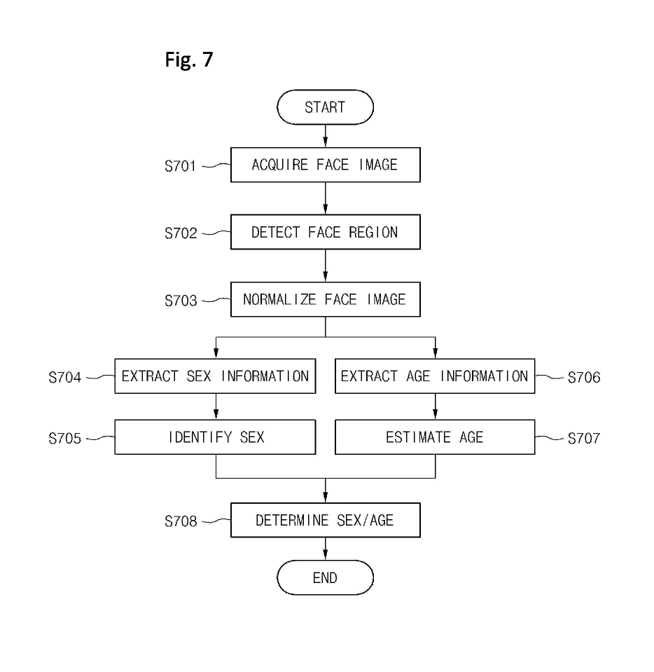

FIG. 7 is a detailed flowchart of the clientele analysis process in FIG. 6. Referring to FIG. 7, the clientele analysis process will be described as follows.

When a user makes a payment request using a payment card, the POS terminal may acquire a face image by taking an image of the user's face through the camera module installed in the signature pad device, and detect a face region from the acquired face image, at steps S701 and S702.

Then, the POS terminal may normalize the face image, and then identify the sex of the user by extracting sex information, while estimating the age of the user by extracting age information.

Then, based on the sex identification result and the age estimation result, the POS terminal may determine the sex and age of the user, and utilize the determined sex and age for user authentication.

In accordance with the embodiments of the present invention, when a user (purchaser) pays with a payment card such as a credit card or check card in a shop, the user authentication apparatus and method may acquire a face image of the user using the camera mounted in the signature pad, acquire the sex and age information of the user by performing clientele analysis on the face image, and perform user authentication for the payment card based on the acquired information. Thus, the user authentication apparatus and method may reliably distinguish a stolen or lost payment card or a payment card used by an unauthorized payment card, thereby preventing a financial accident.

While various embodiments have been described above, it will be understood to those skilled in the art that the embodiments described are by way of example only. Accordingly, the disclosure described herein should not be limited based on the described embodiments.

What is claimed is:

1. A user authentication apparatus for a point of sale data capture (POS) system, comprising:
a signature pad device configured to take an image of a user's face when the user puts an electronic signature to a signature pad in order to pay with a payment card, and transmit the electronic signature information and the taken face image; and
a POS terminal configured to acquire age and sex information from the face image received from the signature pad device by performing clientele analysis on the face image information of the user and store the acquired age and sex information in a DB, when storing data containing a product name or price at a point of sale in the DB.

2. The user authentication apparatus of claim 1, wherein the signature pad device comprises:
a signature pad module configured to receive an electronic signature from the user and transmit the electronic signature information to the POS terminal; and
a camera module installed at one side of the signature pad device, and configured to take an image of the user's face when the user puts the electronic signature to the signature pad module, and transmit the face image information to the POS terminal.

3. The user authentication apparatus of claim 1, wherein the POS terminal comprises:
a sale management module configured to receive the face image information of the user from the signature pad device and transmit the received face image information; and
a clientele analysis module configured to acquire the age and sex information of the user by performing clientele analysis on the face image information of the user, received from the sale management module, and then store the acquired information in the DB.

4. A user authentication apparatus for a POS system, comprising:
a signature pad device configured to acquire a face image by taking an image of a user's face when the user puts an electronic signature to a signature pad in order to pay with a payment card, acquire age and sex information of the user by performing clientele analysis on the face image, and transmit the signature information of the user and the acquired age and sex information of the user; and
a POS terminal configured to receive the electronic signature information and the age and sex information of the user from the signature pad device, and store the received information in a DB.

5. The user authentication apparatus of claim 4, wherein the signature pad device comprises:
a signature pad module configured to receive the electronic signature information from the user;
a camera module configured to acquire the face image by taking an image of the user's face when the user puts the electronic signature to the signature pad module; and
a clientele analysis module configured to acquire the age and sex information by performing clientele analysis on the face image information of the user, received from the camera module.

6. A user authentication method for a POS system, comprising:
acquiring, by a POS terminal, biometric information from a payment card when a user pays with the payment card, and requesting electronic signature information and face image information from a signature pad device;
taking, by the signature pad device, an image of the user's face through a camera module mounted in the signature pad device when the user puts an electronic signature to a signature pad, acquiring clientele analysis information containing age and sex information by performing a clientele analysis process on the taken face image, and transmitting the electronic signature information and the clientele analysis information; and
recognizing, by the POS terminal, the user's face by receiving the clientele analysis information from the signature pad device, and performing user authentication based on the face recognition result.

7. The user authentication method of claim 6, wherein the clientele analysis process comprises:
extracting, by the POS terminal, the face image by taking an image of the user's face through the camera module installed in the signature pad device when the user pays with the payment card;
normalizing the face image, and then identifying the sex and age of the user; and
determining the sex and age of the user based on the identified sex and age, and utilizing the sex and age information for user authentication.
